(19) United States
(12) Patent Application Publication
(10) Pub. No.: US 2002/0029191 A1
(43) Pub. Date: Mar. 7, 2002

(54) Settlement system with IC card, IC card, method of settlement

(75) Inventors: Akira Ishibashi, Tokyo (JP); Masahiro Sakashita, Yokosuka (JP); Masayuki Nakagawa, Ichikawa (JP); Takao Yoden, Saitama (JP); Masashi Takeda, Tokyo (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 09/895,795

(22) Filed: Jun. 29, 2001

(30) Foreign Application Priority Data
Jun. 29, 2000 (JP) 2000-196813

(51) Int. Cl. G06F 17/60

(52) U.S. Cl. 705/39

(57) ABSTRACT

Information of credit cards from a plurality of card companies is previously stored in an IC card, and information of a member who possesses the IC card having a plurality of credit card functions is previously registered in a card company processor. When the IC card is used in a member shop, a terminal in the member shop identifies that the IC card has a plurality of credit card functions, and when carrying out the transaction between a customer and the member shop, establishes the connection to the card company processor. The card company processor establishes the communication with a card company processor specified by the customer. Accordingly, a plurality of credit card functions are provided in one IC card with a plurality of account numbers corresponding thereto.

### BACKGROUND OF THE INVENTION

The present invention relates to an IC card used for settlement, a settlement system employing the same, and a settlement method.

With respect to cards, such as credit cards and debit cards, generally used for settlement (hereinafter, referred to as “existing cards” for short, when applicable), one or more cards is/are issued from one or more card companies each of which a customer joins as a member so that the customer or his/her family may possess one or more cards, and a single settlement account is arranged to correspond to each card company. Thus, if a customer joins a number of card companies, then a number of cards are issued and also a corresponding number of settlement accounts are registered for the cards. If the customer uses one of the number of cards in a transaction, then the transaction amount is settled in the settlement account corresponding to that card.

In the present specification, by “card company” is meant the entity which carries out the settlement for a customer with respect to the transaction performed by presenting a predetermined card by a customer.

As described above, since the existing card is issued by every card company, a customer who joins in a number of card companies must possess a number of cards issued therefrom. So, maintaining and using the cards becomes more difficult for the customer as the number of cards held by the customer increases. Also, where the customer has a number of cards, there is the possibility of the customer accidentally using the wrong card in a transaction.

In addition, each of the existing cards can be arranged to correspond to one or more of the settlement accounts. For example, in the case where an employee uses the existing card having a name of a corporation such as a company, while the employee as a name of a customer can use that existing card as the corporation, he/she can not use that existing card as a name of a private person. In the case as well where a customer is a private customer, the settlement account can not be used appropriately in correspondence to the expenditure. For example, it is impossible that the settlement accounts are provided separately for the life, the taste and the amusement, or for the clothes, the food and the residence, respectively, and then a customer uses appropriately the settlement accounts whenever he/she uses the associated ones of the existing cards.

### BRIEF SUMMARY OF THE INVENTION

In the light of the foregoing, it is an object of the present invention to provide an IC card with one of which a customer (user) can be used for a plurality of settlement accounts appropriately, a settlement system and a settlement method.

The above-mentioned object is based on the request of customers and the recognition of the problems, as will be described below. In the case where a customer possesses a plurality of accounts, if the plurality of accounts can be used appropriately for one IC card, then the request of a customer can be fulfilled. In order to fulfill the request of a customer, making the correspondence between one IC card and a plurality of accounts, and the control for the selection of an account to be used are important.

The above-mentioned object is attained by providing one IC card with the card functions of a plurality of card companies so that the proper use of card companies becomes possible with one IC card. In another aspect, a plurality of settlement accounts are made corresponded to one IC card, whereby the proper use of the settlement accounts becomes possible with one IC card. In still another aspect, the selection of an arbitrary settlement account from a plurality of settlement accounts made corresponded to one IC card can be made, whereby the degree of freedom for the card utilization becomes high.

Other advantages and features of the present invention will be apparent from the accompanying drawings and the description thereof.

### BRIEF DESCRIPTION OF THE DRAWINGS

FIG. 1 is a block diagram showing an example of a configuration of a settlement system according to an embodiment of the present invention;

FIG. 2 is a flow chart useful in explaining the processing in the settlement system of FIG. 1;

FIG. 3 is a block diagram useful in explaining an example of process by which a plurality of existing cards are put together in an IC card;

FIG. 4 is a flow chart useful in explaining the process for registering a member in a central apparatus;

FIG. 5 is a block diagram showing an example of a system configuration for selecting a plurality of accounts;

FIG. 6 is a flow chart useful in explaining the central apparatus when a settlement account is specified for the purposes of settling a number of completed transactions;

FIG. 7 is a diagram showing a statement summary of a number of completed transactions and the corresponding settlement accounts from which funds were withdrawn for settling the transactions;

FIG. 8 is a flow chart useful in explaining the processing in a central apparatus which complies with the account designation received from a transaction terminal;

FIG. 9 is a diagram useful in explaining an example of data structure in a storage device in a central apparatus; and

FIG. 10 is a diagram showing an example of data structure in an IC card.

FIG. 11 shows an IC card and an exemplary information-hierarchy relating to each of a number of cards held together in the IC card, in accordance with one embodiment of the present invention.

### DETAILED DESCRIPTION OF THE INVENTION

Embodiments of the present invention will hereinafter be described in detail with reference to the accompanying drawings.

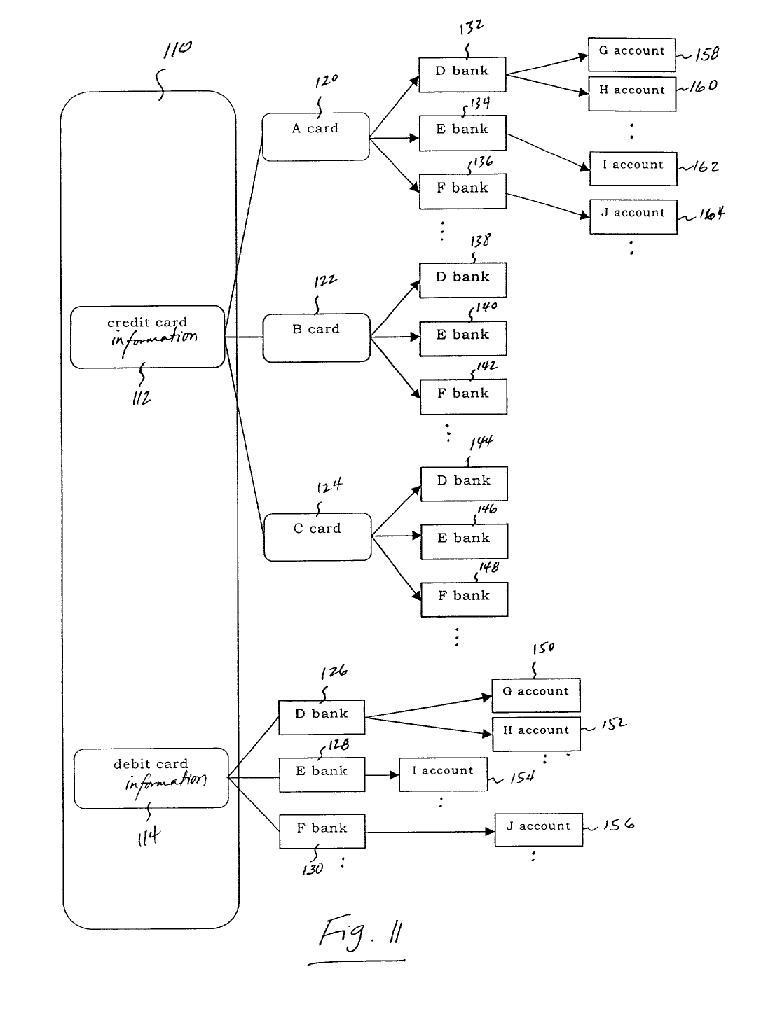

FIG. 11 shows an IC card and an exemplary information-hierarchy relating to each of a number of cards held together in the IC card, in accordance with one embodiment of the present invention. In the example shown in FIG. 11, IC card 110 includes a credit card information bank 112 and a debit card information bank 114. Credit card information bank 112 includes card information corresponding to a plurality of credit cards (A card 120, B card 122, C card 124) to which the IC card-holder has subscribed. Examples of such credit cards would be Visa or Master Card. For each credit card, the IC card-holder may have subscribed to one or more credit card issuing entities. For example, in FIG. 11, the IC card-holder has subscribed to D bank 132, E bank 134, and F bank 136 all of whom issue credit card type A. Further, the IC card-holder may link each credit card issued by each credit card issuing entity to one or more settlement accounts held by the IC card-holder in the corresponding credit card issuing entity. For example, FIG. 11 shows that the card-holder has two settlement accounts, G account 158 and H account 160, at the D bank for the A type of credit card. The IC card-holder in using the IC card to carry out a transaction can choose any one of the three types of credit cards, and any one of the credit card issuing entities corresponding to the selected type of credit card, and any one of the settlement accounts corresponding to the selected entity.

Debit card information bank 114 includes information corresponding to a plurality of financial entities at each of which the IC card-holder maintains one or more settlement account(s). As shown, the card-holder has two settlement accounts (G account 150 and H account 152) at the D bank 126, one account (I account 154) at the E bank 128, and one account (J account 156) at the F bank 130. The card-holder in using the IC card to carry out a transaction has the option of choosing any one of the three financial institutions, and any one of the settlement accounts corresponding to the selected financial institution.

The credit card and debit card information as depicted in IC card 110 in FIG. 11 is merely intended to show the information hierarchy for all the cards that the IC card-holder has the option of choosing from in carrying out transactions. Note that all the card information shown in FIG. 11 may be stored in the IC card, or a portion of it may be stored in the IC card, and the remaining portion may be stored in other locations, such as a central apparatus. Such details as the types of credit card, number of credit card issuing entities and the like, may vary from one IC card-holder to another. As such, FIG. 11 is intended to be illustrative and not limiting.

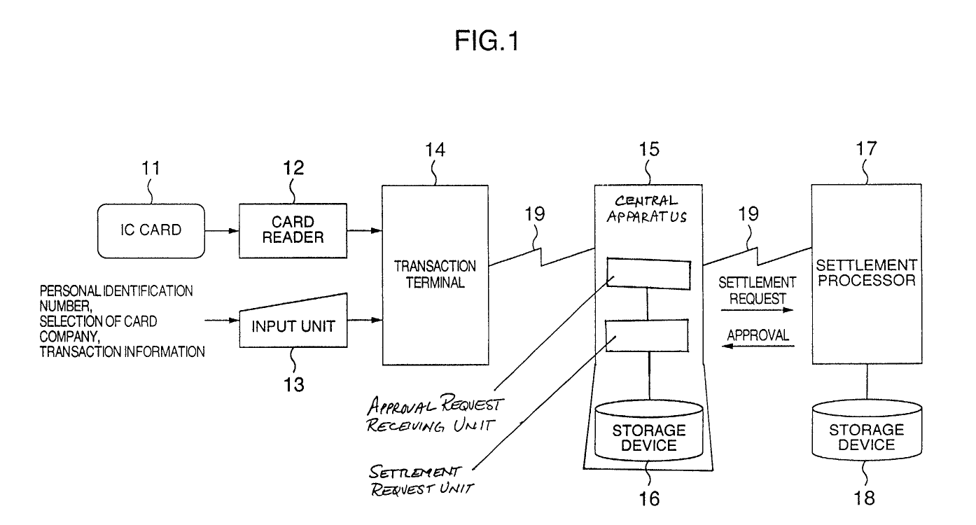

FIG. 1 is a block diagram showing an example of a configuration of a settlement system according to an embodiment of the present invention. In FIG. 1, reference numeral 11 designates an IC card; 12 designates a card reader; 13 designates an input unit; 14 designates a transaction terminal; 15 designates a central apparatus; 16 and 18 designate storage devices; 17 designates a settlement processor; and 19 designates a network such as a communication line or the internet. The transaction terminal 14, central apparatus 15 and settlement processor 17 may be constituted by a computer system called a personal computer or a server.

The card information (e.g., the card numbers, the holders of the card, the identifications of the card companies, the terms of validity for the cards, the utilizable services, and the like) of a plurality of existing cards to be used by the IC card-holder is stored in IC card 11. The IC card ID is also stored in the IC card. In an alternat embodiment, rather than storing the card information in the IC card, the card information may be stored in storage device 16 of central apparatus 15, or may be stored in both IC card 11 and storage device 16.

Transaction terminal 14 is installed in a shop or the like. Both the card reader 12 used for reading out the information stored in IC card 1 1, and input unit 13 used for inputting therethrough a personal identification number, card company designation information, transaction information and the like are electrically connected to the transaction terminal 14. By “card company designation information” is meant the information on the basis of which an arbitrary one of the existing cards' information stored in the IC card 11 is specified.

The central apparatus 15 adapts to request the transactions among a plurality of card companies registered in the IC card 11 and to request the settlement processor 17 to carry out the settlement in a selected settlement account. In addition, the information relating to each member IC card-holder is previously registered in the central apparatus 15.

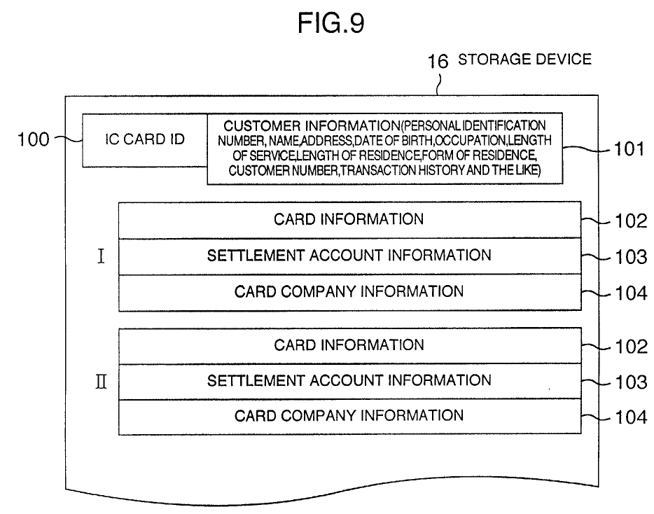

The storage device 16, as shown in FIG. 9, stores therein an IC card ID 100 on the basis of which the IC card 11 is identified, information items 101 relating to a customer as a possessor of the IC card (it will hereinafter be referred to as “customer information” for short, when applicable, and indicates, for example, a name, an address, the date of birth, an occupation, the length of service, the length of residence, the form of residence, a customer number, the transaction history, and the like), card information 102 (for example, a card number, the name of the card-holder, a personal identification number, the term of validity for the card, and the like) corresponding to similar information stored in the IC card, settlement account information 103 (for example, the identification information on the basis of which a financial institution is identified, the identifying information on the basis of which a branch is identified, an account number, the kind of account, and the like), and card company information 104 (for example, a card company identifier, a name of a card company (i.e., a card-issuing company), an address, data format of settlement request information, and the like. These information are configured in storage device 16 so that they properly correspond to one another. A plurality of sets of card information 102, settlement account information 103 and card company information 104 may be present as shown in the form of blocks I and II in FIG. 9.

“Card company” as used in this specification has a different meaning when discussing credit cards than when discussing debits cards. In the context of credit cards, “card company” refers to the credit card company, such as Visa, Master card, and not the financial institution (e.g., a bank) at which the IC card-holder holds his or her settlement account(s). But, in the context of a debit card, “card company” refers to the financial institution (e.g., a bank).

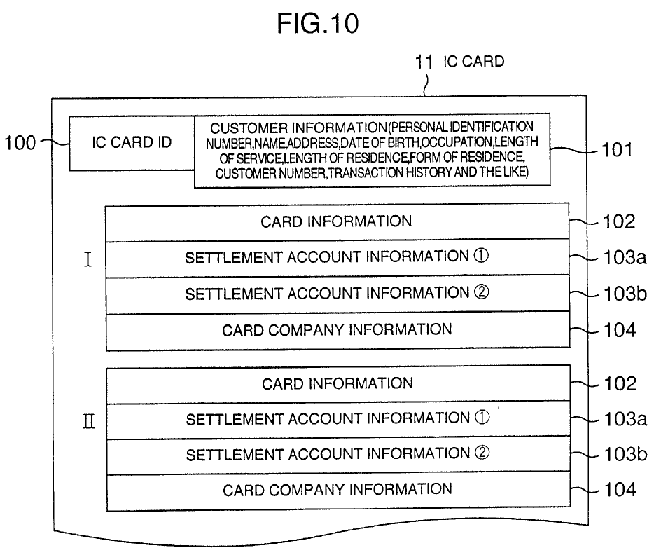

FIG. 10 shows a number of sets of information, including information sets I, II, stored in the IC card, wherein the information sets I, II correspond to the information sets I, II stored in the storage device 16 (FIG. 9) of the central apparatus. In FIG. 10, each set of information I, II is shown as having multiple settlement accounts 103a, 103b. This is to illustrate the case wherein the IC card-holder has multiple settlement accounts in each card company at which the IC-card holder is a member.

The card information 102 and the settlement account information 103 may be stored either in the IC card 11 (as shown in FIG. 10) or in both the storage device 16 and the IC card 11.

In FIG. 1, the settlement processor 17 is a processor installed in a card company and adapts to execute the settlement processing in accordance with a predetermined inputted data. For example, in a transaction, if the IC card-holder selects a credit card from his/her IC card, then the settlement processor 17 installed in the card company (i.e., the credit card company such as Visa or Master Card) requests the financial institution (such as a bank) managing IC card-holder's settlement account(s) to carry out the settlement. On the other hand, if the IC card-holder selects a debit card from his/her IC card, the settlement processor 17 installed in the card company (i.e., the financial institution such as a bank) carries out the process of debiting the transaction amount from the settlement account of the IC card-holder. The settlement processor 17 has the storage device 18 for storing therein the customer information (e.g., a name, an address, a telephone number, a post code, the date of birth, the customer's place of work, a card number, a customer's personal identification number, the date of the contract, the term of validity for a card, transaction history, payment history, a financial institution for utilization, a name of a branch of a financial institution, the kind of account, an account number, the limited amount for utilization and the like). While simplified in FIG. 1, a plurality of settlement processors 17 electrically connected to the central apparatus 15 are present. Each of the settlement processors may manage a plurality of accounts for the same customer.

In FIG. 1, even when the IC card is used in a shop as for example a credit card, the transaction terminal 14 is electrically connected to the card company (who issued the card of the customer) to execute the same processing as that in conventional methods.

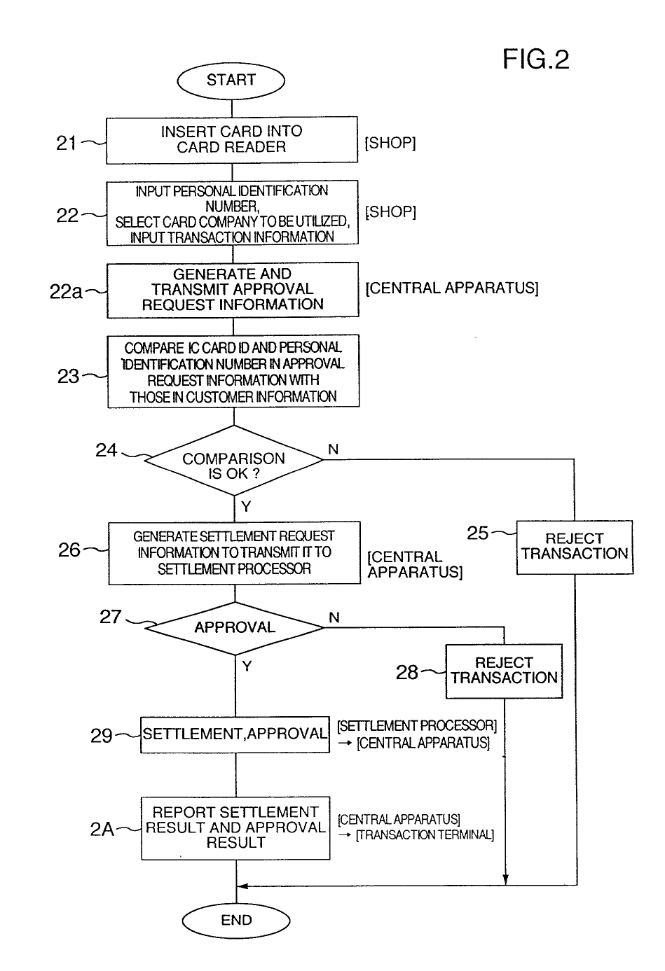

The operation of the system shown in FIG. 1 will hereinbelow be described with reference to a flow chart shown in FIG. 2. When a customer uses the IC card 11 by, for example, inserting the IC card 11 into the card reader 12 in a shop (Step 21), then the transaction terminal 14 reads out the IC card ID and a plurality of card information stored in the IC card 11.

After inputting the card company designation information, the customer's personal identification number, and the transaction information (e.g., name of a member shop, a member shop code, the date and time of transaction, one or more purchased product(s), the transaction amount, the payment method by the customer, and the like) in the input unit 13 (Step 22), the transaction terminal 14 generates approval request information which includes the card information, the transaction information, the customer's personal identification number, the IC card ID, the card company designation information and the like, and the approval request information thus generated is transmitted to the central apparatus 15 through the network 19 (Step 22a).

The central apparatus 15 receives the approval request information from the transaction terminal 14, compares the customer's private code number and the IC card ID contained in the approval request information with the customer's private code number and the IC card ID 100 contained in the customer's information 101 stored in the storage device 16, and if the information do not match, informs the transaction terminal 14 that the transaction can not be carried out (Steps 23 to 25). This confirmation step is carried out to ensure that the IC card is being used by an authorized card-holder.

On the other hand, if the information matches, then the central apparatus 15 generates the history information of the transaction on the basis of the transaction information and the card information, stores the generated history information in the storage device 16 (the illustration thereof is omitted here), generates settlement request information containing the transaction information and the card information, and transmits the settlement request information thus generated to the settlement processor corresponding to the selected card (Step 26). The settlement request information is generated in accordance with a predetermined data format in correspondence with the data format of the settlement processor to which the settlement request information is transmitted. The information relating to the predetermined data format is stored in the storage device 16 in the central apparatus 15 in correspondence with each card company's ID (the illustration thereof is omitted here).

Based on the transaction information and the card information contained in the received settlement request information, the settlement processor 17 determines whether or not the transaction can be approved. If the settlement processor 17 determines that the transaction can not be carried out, the settlement processor 17 transmits a 5 transaction-rejection-notification to the central apparatus 15. Thereafter, the central apparatus 15 transfers the transaction-rejection-notification to the transaction terminal 14 (Steps 26 to 28).

On the other hand, in step 27, if the settlement processor 17 determines that the transaction can be approved, then the settlement processor 17 carries out the settlement processing to generate both the transaction-approval-notification and the transaction-copy-information and transmits such information as the approval information to the central apparatus 15 through the network 19 (Step 29). The central apparatus 15 transfers the transaction-approval-information and the transaction-copy-information received from the settlement processor 17 to the transaction terminal 14 through the network (Step 2A). The transaction terminal 14 outputs both the transaction-approval-notification and the transaction-copy-information. The transaction-copy-information is printed out through an output terminal such as a printer, and offered to the customer.

In the case where the IC card ID is stored in the IC card 11, but the card information corresponding to the IC card ID is stored in the storage device 16 of the central apparatus 15 (rather than in the IC card itself), an embodiment described next may also be adopted.

The transaction terminal 14 receives the IC card ID stored in the IC card 11 through the card reader 12, and also receives the transaction information from the input unit 13. The transaction terminal 14 transmits the IC card ID thus received to the central apparatus 15. The central apparatus 15 receives the IC card ID, and uses the received IC card ID as a key to retrieve the IC card ID stored in the storage device 16, and thus be able to retrieve the corresponding card information 102, the settlement account information 103 and the card company information 104 (e.g., one of the blocks I, II in FIG. 9). The central apparatus then transmits the card information thus retrieved to the transaction terminal 14.

The transaction terminal 14 outputs the received card information in visible form, and receives the card company designation information from the IC card-holder through the input unit 13. Then, the transaction terminal 14 transfers the card company designation information thus received to the central apparatus 15. Here, since the information outputted through the transaction terminal 14 only has to contain the information necessary for a customer to select one of the blocks 1, II in FIG. 9, the central apparatus 15 does not need to read out all of the information from the storage device 16 as was done in process of FIG. 2 described above.

The central apparatus 15 generates the settlement request information on the basis of the card information 102 corresponding to the received card company designation information (corresponding to the card company information 104 in the storage device 16), the settlement account information 103 and the transaction information, and transmits the settlement request information thus generated to the settlement processor corresponding to the card company specified in the card company designation information. The subsequent processing steps are the same as those in the above-described FIG. 2 approach.

In the present embodiment, when the transaction terminal 14 receives the transaction-rejection-notification (Step 28 in FIG. 2), the card company designation information is transmitted from the transaction terminal 14 to the central apparatus 15 again, whereby the re-experimentation does not need to be carried out from the operation of reading out the contents of the IC card 11, and hence the processing procedure can be simplified.

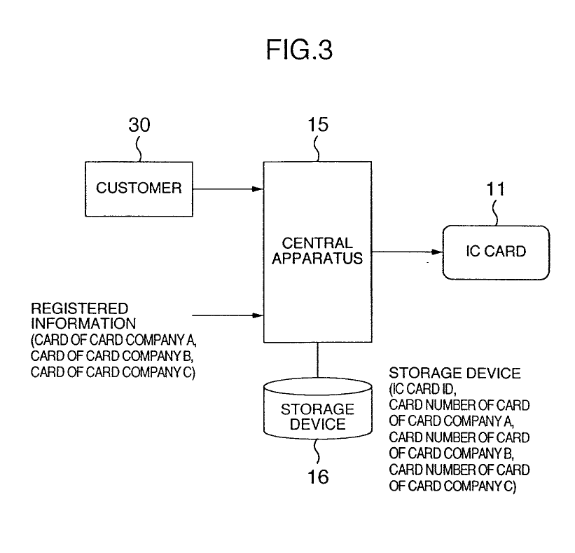

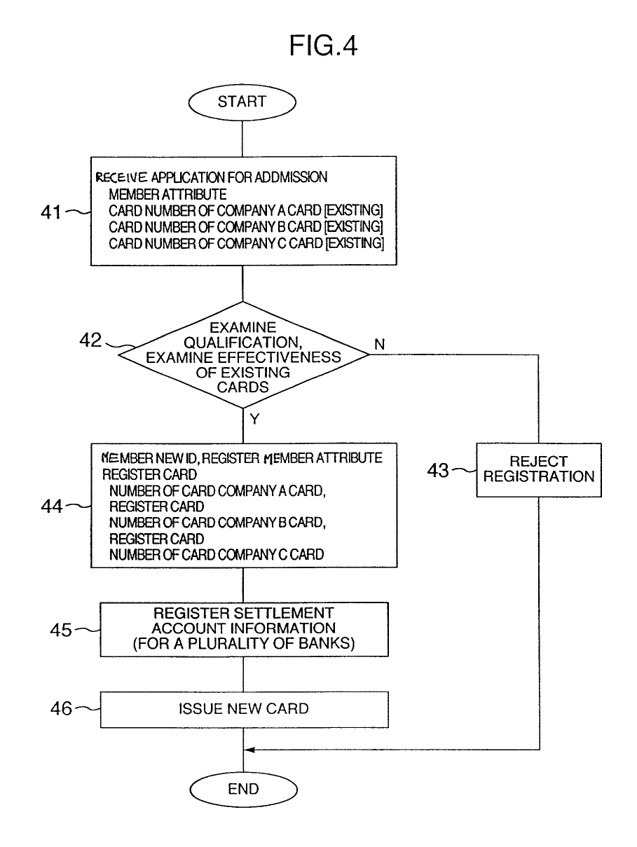

FIG. 3 (which shows a block diagram) and FIG. 4 (which shows a flow chart) will be used to describe a system and process wherein a customer who possesses multiple existing cards wishes to put them together in one IC card 11 and register the required information in central apparatus 15 to enable the customer to use the IC card. In FIG. 3, reference numeral 30 designates a customer, and other reference numerals are the same as those in FIG. 1. The description will hereinbelow be given with respect to the processing of registering a member in the central apparatus 15 when registering a plurality of existing cards in the IC card 11.

As shown in FIG. 3, the customer 30 who possesses a plurality of existing cards and wishes to put them together in one IC card 11 inputs the information relating to himself or herself into the central apparatus 15 to register information relating to himself or herself in the storage device 16 as a member. At this time, the customer 30 makes the central apparatus 15 read out the contents of the existing cards not yet put together in the IC card. In an example shown in FIG. 3, the customer 30 possesses three existing cards issued by card companies A, B, and C. The central apparatus 15 registers the card contents of the card companies in the storage device 16 in accordance with the inputted content of these card, and issues the IC card 11 on the basis of such information.

The process of putting the existing cards together in the IC card 11 may be carried out by reading out the content of each of the plurality of existing cards using card reader 12, and then processing the obtained content through the transaction terminal 14 to put the existing together in the IC card. Also, a customer may access the central apparatus 15 by using the PC or the like to carry out the process of putting the existing cards together in the IC card 11.

The process of registering a card member in the central apparatus 15 is executed in accordance with the flow chart shown in FIG. 4. The central apparatus 15 receives an application for admission from a customer, the customer information as the member attribute, and the contents of the existing cards (not yet put together in the IC card) which the customer possesses (Step 41) to examine the qualifications of the customer and the effectiveness of his or her existing cards (Step 42). If the central apparatus 15 determines that a customer does not have the qualification to apply, then the registration is refused (Step 43). The qualification determination process is carried out in a manner similar to that carried out by card companies. The central apparatus 15 may independently carry out the examination for qualification determination, or alternatively, a person in charge of qualification determination carries out the examination interactively in conjunction with the central apparatus 15.

At the examination step 42, if the central apparatus 15 determines that a customer has the qualification to apply, the given IC card ID 100 and the customer information 101 are registered in the storage device 16, and also the contents of the customer's existing cards are registered as, for example, information sets I, II in FIG. 9 (Step 44).

The central apparatus 15 then requires the customer to input settlement account information to be used in processing transactions, registers the settlement account information in the storage device 16, issues a new IC card, thereby completing the processing (Steps 45 and 46). The card contents of the customer's existing cards are stored in the IC card 11. In Step 45, the information of a plurality of banks and a plurality of accounts can be inputted as the settlement account information. If a customer decides that only the settlement account information stored in his or her existing cards is enough (i.e., the settlement account information need not be registered at the central apparatus), the processing in Step 45 may omitted. (Steps 45 and 46).

In this connection, the procedure may be adopted to a way that the IC card ID is stored in the IC card itself, and the contents of the corresponding IC cards are stored in the storage device 16 of central apparatus 15.

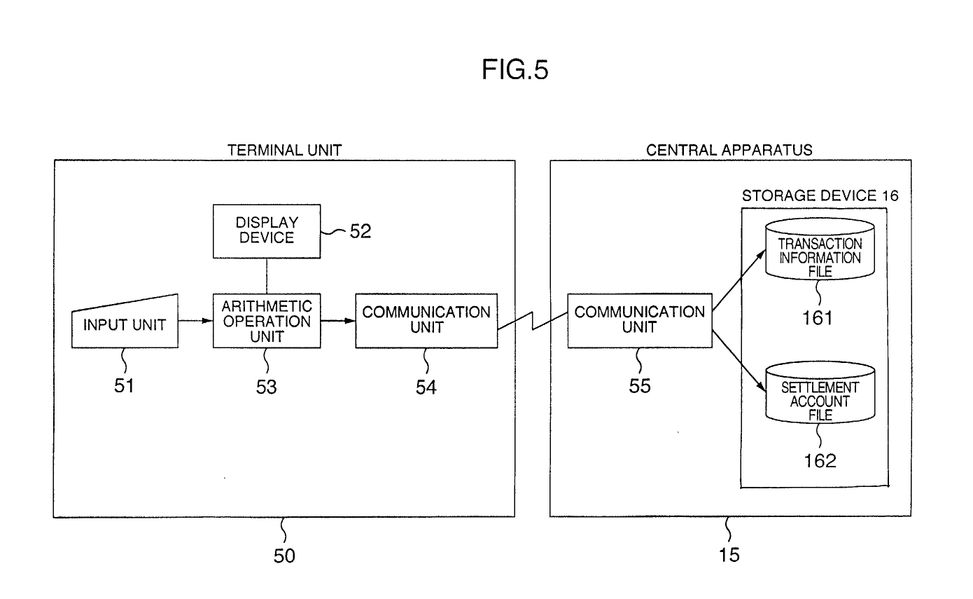

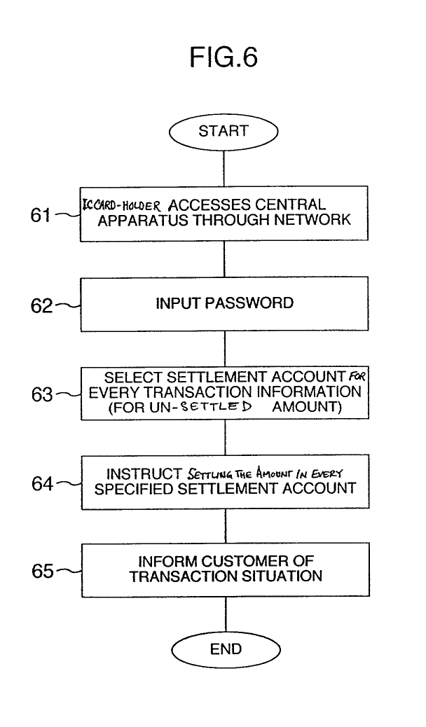

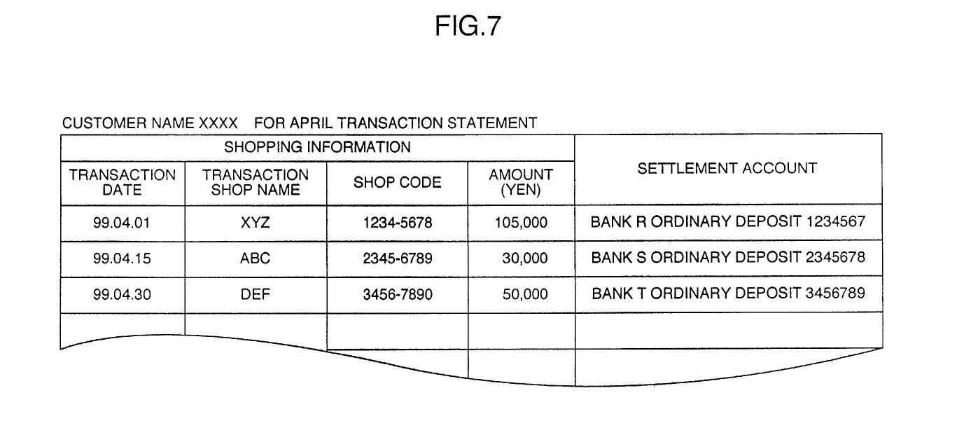

FIG. 5 is a block diagram showing an example of a system configuration in the case where a plurality of settlement accounts correspond to the IC card (which has the information of one or a plurality of card(s)), and a customer selects one of the settlement accounts to process a transaction. FIG. 6 is a flow chart used in explaining the processing operation in the central apparatus 15 when one of the settlement accounts is specified. FIG. 7 is a diagram used in explaining the transaction statement. In FIG. 5, reference numeral 50 designates a terminal unit, 51 designates an input unit, 52 designates a display device, 53 designates an arithmetic operation unit, 54 and 55 designate communication units, 161 designates a transaction information file, 162 designates a settlement account number file, and other reference numerals are the same as those in FIG. 1. Although the terminal unit 50 is shown to include the input unit 51, the terminal unit 50 essentially does not differ from the terminal unit 14 shown in FIG. 1 in terms of the computer system.

Note that the process described using FIGS. 5-7 corresponds to transactions wherein the IC card is used as a credit card, not a debit card. An exemplary process would be where a transaction has been completed using a credit card selected from the IC card (i.e., the customer has made a purchase and the merchant has processed the customer's credit card and holds a credit card slip corresponding to the purchase), but the purchase amount is not deducted from the customer's settlement account until a later time (e.g., until the end of the month when the credit card company totals all of the customer's transactions in the prior month and deducts the total amount from the customer's designated settlement account.

The description will hereinbelow be given with respect to the case where a plurality of settlement accounts are arranged to correspond to the settlement account information 103a and 103b (FIG. 10) in the IC card, and a customer can select any one of the settlement accounts from which the transactions amounts from one or more previously completed transactions can be deducted. The terminal unit 50 which a customer uses may either be the same as terminal unit 11 shown in FIG. 1, or may be the PC or the like which a customer possesses. In addition, the central apparatus 15 includes the communication unit 55 and also includes both the transaction information file 161 and the settlement account file 162 in the storage device 16.

In response to the designation of a settlement account by a customer, the central apparatus 15 generates the corresponding settlement account file 162 in such a way that the transaction shops, the dates of the transactions and the settlement account correspond to one another. The designation of the settlement account in the central apparatus 15 will hereinbelow be described with reference to the flow chart shown in FIG. 6.

After completion of a transaction, the customer, by using the terminal unit 50, accesses the central apparatus 15 through a network, such as the internet, to input thereto a password (Steps 61 and 62). The central apparatus 15 transmits both the information on the transactions not yet settled (i.e., transactions wherein the transaction amounts have not yet been deducted from the customer's settlement account(s)), and the settlement account information indicating the account in which the transactions that have not yet been settled can be settled to the terminal unit 50 where they are displayed on the display device. The displayed information, as shown in FIG. 7, contains the date of the transaction, the shop name for the transaction, the shop code, the amount of money in the transaction, and the settlement accounts. Here, all of the selectable settlement accounts need not be displayed, but rather the settlement account previously registered as the default account may be displayed.

A customer selects a settlement account for every transaction and transmits this selection information to the central apparatus 15 (Step 63). The central apparatus 15 instructs the corresponding settlement accounts to settle the transaction amounts and send a corresponding transaction statement back to the customer. In the transaction statement, an example of which is shown in FIG. 7, the settlement accounts specified by the customer are recorded (Steps 64 and 65). When a customer does not specify the settlement account within a predetermined time frame, the settlement account previously registered as the default account is automatically selected as the settlement account.

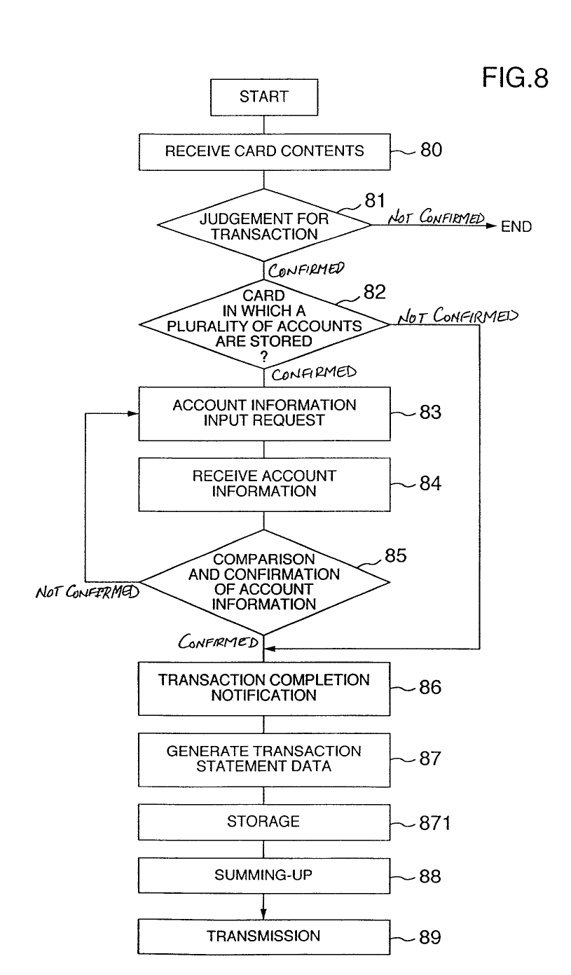

In an alternate approach, right after completion of a transaction at, for example, a store, the settlement account may also be specified from the transaction terminal 14 by using the IC card. In this case, the central apparatus 15 having been accessed from the transaction terminal 14 executes the processing in accordance with the flow chart shown in FIG. 8.

The central apparatus 15 receives the card contents from the transaction terminal 14 to confirm whether or not the IC card 11 of interest is the card with which the central apparatus can communicate. To carry out the confirmation, the information relating to the IC card 11 stored in the storage device 16 is employed. In the case where there is not such information stored in the storage device 16, the central apparatus 15 may access the settlement processor 17 which issued the existing card and has the contents of the IC card 11 of interest to confirm whether or not the IC card 11 of interest is the proper card with which the central apparatus can communicate (Step 81).

The central apparatus 15 determines whether or not the IC card 11 of interest is set in such a way as to be able to utilize a plurality of accounts (Step 82). After completion of the confirmation in Step 82, the central apparatus 15 transmits a settlement-account-information-input-request to the transaction terminal 14. The transaction terminal 14 receives the requested settlement account information from the IC card-holder, and transmits the settlement account information thus received to the central apparatus 15 (Steps 83 and 84).

The central apparatus 15 confirms the settlement account information, and after completion of the processing for the transaction, transmits the transaction-completion-notification to the transaction terminal 14, generates the data of transaction utilization statement, and stores the data thus generated in the storage device 16 (Steps 85, 86, 87 and 871).

The central apparatus 15 prepares a summary of the data of the transaction statement in the storage device 16. In preparing the summary, for example, the transactions which correspond to the same customer, same account, and same due date for settlement of accounts are arranged together for every settlement processor 17 (Step 88). The central apparatus 15 sends the summary of the transaction statement in Step 88 to the settlement processor 17. The summary of the transaction statement is stored in the storage device 18 connected to the settlement processor 17 (Step 89).

The processing in the central apparatus 15 can be realized in the form of a program. This program may be stored in a portable recording medium such as a magnetic disc or an optical disc, or is provided through the network.

When the IC card 11 to which a plurality of settlement accounts are arranged to correspond is used in a member shop (i.e., a shop recognized by the IC card system), the central apparatus 15 can separate the transactions, total the transaction amounts corresponding to each settlement account, and instruct each settlement account to settle (pay) the corresponding total transaction amounts.

As a result, the individual card companies issuing the cards do not need to execute the processing of separating the claims for a plurality of accounts, which customers have in the card companies themselves.

The customer, in designating the settlement accounts in which the transaction amounts are to be settled, can input the payment condition such as the revolving charge account payment. When the information relating to the payment condition is inputted, the central apparatus 15 instructs the settlement of the transaction based on the method instructed by the settlement processor 17 in accordance with the payment condition.

In accordance with the invention, since a plurality of card information can be included in one IC card 11 and/or a plurality of settlement account numbers can be arranged to correspond to one IC card 11, the member customers do not need to carry a number of cards. In addition, the transaction, in which one of a plurality of card companies is selected, can be carried out using one card, and in accordance with the selection made by a customer, the settlement can be carried out with an arbitrary settlement account selected from a plurality of settlement accounts. As a result, the above-mentioned example of use of the corporate card becomes possible, and also it becomes possible that a housewife or the like in a household uses the appropriate settlement accounts for every expenditure in the household economy, or uses the appropriate settlement account for the household economy and for private use. In addition, in the case where the IC card is used in overseas travels, when carrying out the payment on the basis of the conversion into foreign currency, an account of a financial institution which has inexpensive financial charge for the conversion into foreign currency can be specified.

As set forth hereinabove, according to the present invention, a customer (a user of an IC card) can use a plurality of settlement accounts with one card.

While the present invention has been particularly shown and described with reference to the preferred embodiments, it will be understood that the various changes and modifications will occur to those skilled in the art without departing from the scope and true spirit of the invention. The scope of the invention is therefore to be determined solely by the appended claims.

What is claimed is:

1. A settlement system configured to process transactions, the settlement system comprising:
an IC card;
a transaction terminal;
a plurality of settlement processors; and
a central apparatus coupled to communicate with the plurality of settlement processors and the transaction terminal, the transaction terminal being configured to transmit information between the central apparatus and the IC card, the central apparatus comprising:
an IC card-holder information storage unit configured to store therein: (i) IC card identification information based on which each of a plurality of IC cards including said IC card can be uniquely identified, and (ii) settlement processor information based on which each of said settlement processors can be uniquely identified, wherein each of said plurality of IC cards corresponds to predesignated one or more of the settlement processors;
an approval request receiving unit configured to receive, through said transaction terminal, IC card identification information, settlement processor designation information for specifying one or more of the plurality of settlement processors, and transaction information containing transaction amount data; and
a settlement request unit configured to generate settlement request information based on the transaction information and the settlement processor designation information, and to transmit the settlement request information thus generated to one or more settlement processors specified by the settlement processor designation information.

2. A method of processing a transaction using an IC card, the method comprising:
storing IC card identification information based on which each of a plurality of IC cards can be uniquely identified and settlement processor information based on which each of a plurality of settlement processors can be uniquely identified, wherein each of said plurality of IC cards corresponds to predesignated one or more of the settlement processors;
receiving approval request information generated by a transaction terminal in response to a transaction initiated using said IC card, the approval request information containing IC card identification information corresponding to said IC card, settlement processor designation information specifying one of the plurality of settlement processors corresponding to the IC card, and transaction amount information;
generating settlement request information based on the approval request information; and
transmitting the settlement request information to the specified settlement processor.

3. The method of claim 2 further comprising:
determining whether to approve settlement of said transaction based on the transmitted settlement request information and information contained in a pre-selected settlement account from which the settlement amount may be withdrawn if the settlement of the transaction is approved; and
if the transaction is approved, generating individual statement information exhibiting the transaction amount for a predetermined period of time every settlement processor identification information on the basis of the approval request information.

4. The method of claim 2, wherein each of said plurality of settlement processors is identified by a distinct settlement processor identification information, said plurality of settlement processors including a first settlement processor maintained at the same location where the settlement account from which funds are withdrawn for settlement of the transaction is maintained, and a second settlement processor maintained at a location different from the location where the settlement account is maintained.

5. The method of claim 4, wherein the settlement processor designation information includes a first information item based on which a first settlement processor identification information corresponding to said first settlement processor is specified, and second information item based on which a second settlement processor identification information corresponding to said second settlement processor is specified.

6. The method of claim 2 wherein said settlement request information is generated in a data format corresponding to the data format of the specified settlement processor.

7. A computer system connected to a plurality of settlement processors through a network, said computer system comprising:
means for inputting therethrough information relating to the transaction;
means for inputting therethrough the contents of an IC card;
means for selecting one of a plurality of settlement processor information contained in said IC card; and
an output unit for outputting to one of said plurality of settlement processors the inputted contents of said IC card corresponding to the information relating to the transaction and the selection information.

8. The computer system of claim 7, wherein said means for inputting therethrough the transaction information, said means for inputting therethrough the contents of said IC card, and means for selecting collectively form the means for inputting input information to an apparatus different from said computer system through said network.

9. A computer system connected to a plurality of settlement processors through a network, said computer system comprising:
storage device for storing therein information relating to the relationship between at least one of said plurality of settlement processors and a card;
a unit for inputting therethrough information relating to a transaction;
a unit for inputting therethrough information specifying said card;
means for specifying at least one, of said plurality of settlement processors, corresponding to the card specification information; and
an output unit for outputting therethrough the information relating to the transaction to one of said at least one settlement processor which is specified.

10. A computer system according to claim 9, wherein said specification means includes:
a unit for when a plurality of settlement processors corresponding to the card specification information are present, outputting the information relating to said plurality of settlement processors; and
an input unit for inputting therethrough the information specifying at least one of said plurality of settlement processors in correspondence to the output of the information relating to said settlement processors made by said output unit.

11. A computer system according to claim 9, wherein said storage device stores therein the information which is required for the settlement processing of the settlement processor corresponding to said card, and said output unit for outputting therethrough the transaction information outputs the information required for the settlement processing in said storage device.

12. A computer system connected to a settlement processor(s) through a network, said computer system comprising:
a unit for inputting therethrough the information relating to a transaction;
a unit for inputting therethrough the contents of a IC card;
an input unit for inputting therethrough the information relating to a settlement account concerned with the transaction; and
an output unit for outputting therethrough the information relating to the transaction and the settlement account information to said settlement processor(s).

13. A computer system according to claim 12, wherein the plurality of settlement processors are present, wherein said computer system furtherer comprises a unit for inputting therethrough the information on the basis of which one of the plurality of settlement processor information contained in said IC card, and wherein said output unit outputs the information relating to the transaction and the settlement account information to one of said plurality of settlement processors on the basis of the selection information.

14. A computer system according to claim 12, wherein the information relating to a plurality of settlement accounts is contained in the contents of said IC card, and the information relating to the plurality of settlement accounts contains therein the information on the basis of which one of the settlement accounts is selected from the information relating to the plurality of settlement accounts.

15. An IC card comprising:
an area in which the information relating to a plurality of settlement processors is stored; and
an area in which the information relating to settlement accounts is stored in correspondence to the information relating to said plurality of settlement processors,
wherein the information relating to said plurality of settlement processors is read out in correspondence to a transaction, and the information relating to the settlement accounts is read out in correspondence to the information on the basis of which one of said plurality of settlement processors is selected from the read out information relating to said plurality of settlement processors.

16. An IC card comprising:
an area in which the information relating to settlement processors is stored; and
an area in which the information relating to a plurality of settlement accounts is stored in correspondence to the information relating to settlement processors,
wherein the information relating to the plurality of settlement accounts is read out in correspondence to a transaction, and in correspondence to the information on the basis of which one of the plurality of settlement accounts is selected from the read out information relating to the plurality of settlement accounts, the transaction is settled through the selected settlement account.

17. A processing method for use in a computer system connected to a plurality of settlement processors through a network, said processing method comprising the steps of:
inputting the information relating to a transaction;
inputting the contents of an IC card (11);
inputting the information on the basis of which one of the plurality of settlement processor information contained in said IC card is selected; and
outputting the inputted contents of said IC card corresponding to the information relating to the transaction and the selected information to one of said plurality of settlement processors on the basis of the selection information.

18. A processing method for use in a computer system which is electrically connected to a plurality of settlement processors through a network and which includes a storage device for storing therein the information relating to the relationship between at least one of said plurality of settlement processors and a card, said processing method comprising the steps of:
inputting the information relating to Ma transaction;
inputting the information specifying said card;
specifying at least one, of said plurality of settlement processors, corresponding to the card specification information; and
outputting the information relating to the transaction to one of said at least one settlement processor which has been specified.

19. A processing method according to claim 18, wherein said specification step includes the steps of:
when the plurality of settlement processors corresponding to the card specification information are present, outputting the information relating to said plurality of settlement processors; and
inputting the information on the basis of which at least one of said plurality of settlement processors is specified in correspondence to the output of the information relating to said plurality of settlement processors.

20. A processing method according to claim 18, wherein said storage device stores therein the information required for a settlement processing of said settlement processors corresponding to said card, and information required for the settlement processing in said storage device and which corresponds to the output of the transaction information.

21. A processing method in a computer system connected to a settlement processor(s) through a network (19), said processing method comprising the steps of:
inputting the information relating to a transaction;
inputting the contents of an IC card;
inputting the information relating to a settlement account concerned with the transaction; and
outputting the information relating to the transaction and the settlement account information to said settlement processor(s).

22. A processing method according to claim 21, wherein when the plurality of settlement processors are present, the information on the basis of which one of the plurality of settlement processor information contained in said IC card is inputted, and the information relating to the transaction and the settlement account information are outputted to one of said plurality of settlement processors on the basis of the selected information.

23. A processing method according to claim 21, wherein when the information relating to a plurality of settlement accounts is contained in the contents of said IC card, the information relating to the settlement account contains the information on the basis of which one of the information relating to the plurality of settlement accounts is selected.
